(19) United States
(12) Patent Application Publication
(10) Pub. No.: US 2003/0210701 A1
(43) Pub. Date: Nov. 13, 2003

(54) Network supervisory control system

(76) Inventors: Koichi Saiki, Kawasaki (JP); Takashi Okuda, Kawasaki (JP); Junichi Shimada, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/446,957

(22) Filed: May 28, 2003

Related U.S. Application Data
(63) Continuation of application No. PCT/JP00/08481, filed on Nov. 30, 2000.

(51) Int. Cl. H04L 12/56

(52) U.S. Cl. 370/401; 370/258

(57) ABSTRACT

The present invention relates to a network supervisory control system so arranged that load distribution control of a plurality of transmission devices constituting a network is performed by disposing a gateway server between the transmission devices and a supervisory control device for remotely performing the supervisory control of the transmission devices. The network supervisory control system comprises a supervisory control device, a plurality of transmission devices, at least one particular transmission device of the plurality having a gateway function for traffic information in the network, and a gateway server, wherein the gateway server monitors traffic conditions in the network given from the particular transmission device, and assigns a transmission device other than said particular transmission device to a new particular transmission device, when predetermined traffic information is beyond a predetermined threshold, to link up a new supervisory line between the gateway server and the new particular transmission device.

### CROSS-REFERENCE TO RELATED APPLICATION

This application is a continuation application and is based upon PCT/JP00/08481 which was filed on Nov. 30, 2000.

### FIELD OF THE INVENTION

The present invention relates to a network supervisory control system and, in particular, to a plurality of transmission devices constituting a ring network used for a basic trunk, etc., connecting metropolises such as Tokyo and Osaka, and a supervisory control device for remotely performing the supervisory control of the transmission devices. In such a ring network, each of the transmission devices passes supervisor control information to the other through a supervisory control line (hereinafter called a DCC (Data Communication Channel)), in which the supervisory control device is physically connected with a particular transmission device (hereinafter called GNE (Gateway Network Equipment) of the transmission devices, and passes supervisory control information to the GNE, on the basis of a predetermined communication protocol, in order to perform supervisory control of the ring network.

### BACKGROUND OF THE INVENTION

In a conventional network supervisory control system, when supervisory control of a ring network is performed, one of the transmission devices in the network is assigned as a GNE, and a supervisory control device performs the supervisory control of all other transmission devices in the ring network via the GNE. For this reason, the conventional system has the following problems.

(1) When DCC traffic increases due to a surge of troubles on the transmission devices, communication traffic between the GNE and the supervisory control device and transmission devices suddenly increases and, in particular, a load to be processed by the GNE connected with the supervisory control device increases, and the throughput and the response speed of the supervisory control device, for various operations of the transmission devices, consequently deteriorate.

(2) When the GNE itself goes down due to troubles, etc., communication paths between the supervisory control device and the transmission devices are interrupted and, thereby, the supervisory control device is unable to perform the supervisory control of the network, and the operation of the network becomes difficult.

(3) When the number of transmission devices in a ring network, to which supervisory control is performed, is increased, communication traffic between the GNE and the supervisory control device and transmission devices increases in proportion thereto, and as in case of (1) the throughput and the response speed of the supervisory control device deteriorate as a result of an increase in the load on the GNE. Due to the increase in the number of transmission devices to be processed, the load to be processed by the supervisory control device increases and, thereby, the usability of the supervisory control device deteriorates.

In order to solve the above problems, a supervisory control system is required to be capable of performing supervisory control of a ring network with stability even if the load of the GNE increases and/or troubles occur in the GNE.

### DISCLOSURE OF THE INVENTION

It is therefore an object of the present invention to provide a network supervisory control system capable of:

(1) maintaining a necessary response speed of the supervisory control device for various operations of transmission devices in a ring network and even if a surge of troubles occur on the transmission devices,

(2) securing the operation of the supervisory control device and minimizing the effect on the operation of the network also if the GNE itself goes down due to troubles, etc.

(3) maintaining a necessary response speed of the supervisory control device for various operations of transmission devices and minimizing the effect on the operation of the network even if the number of transmission devices in a ring network increases or the number of ring networks increases.

According to the present invention, there is provided a network supervisory control system comprising a supervisory control device for performing supervisory control of a network, a plurality of transmission devices connected with each other to constitute the network, at least one particular transmission device of the plurality of transmission devices, having a gateway function for traffic information in the network, and a gateway server disposed between the supervisory control device and the particular transmission device, through which gateway server the supervisory control device and the particular transmission device are connected, wherein the gateway server monitors traffic conditions in the network from the particular transmission device, and assigns a transmission device other than the particular transmission device to a new particular transmission device, when predetermined traffic information is beyond a predetermined threshold, to link up a new supervisory line between the gateway server and the new particular transmission device.

Further, according to the present invention, there is provided a network supervisory control system comprising a plurality of supervisory control devices for performing supervisory control of a network, databases furnished at the plurality of supervisory control devices respectively, a plurality of transmission devices connected with each other and constituting the network, at least one particular transmission device of the plurality of transmission devices, having a gateway function for traffic information in the network, and a gateway server disposed between the plurality of supervisory control devices and the particular transmission device, through which gateway server the plurality of supervisory control devices and the particular transmission device are connected, wherein the gateway server monitors matching states between the plurality of databases and, when it detects an inconsistency of data contents between the plurality of databases, the gateway server matches data contents of the databases with data contents of a particular database thereof.

### BRIEF DESCRIPTION OF THE DRAWINGS

FIG. 1 shows the basic configuration of an example of a network supervisory control system according to the present invention.

FIG. 2 shows the configuration of an example of a GNE according to the present invention.

FIG. 3 shows the configuration of an example of a gateway server according to the present invention.

FIG. 4 shows an example of a link switching sequence of the system shown in FIG. 1.

FIG. 5 shows a modification of the system shown in FIG. 1.

FIG. 6 shows the configuration of another example of a network supervisory control system according to the present invention.

FIG. 7 shows an example of a database matching sequence of the system shown in FIG. 6.

FIG. 8 shows an example of contents of the database of a supervisory control device.

### BEST MODE OF CARRYING OUT THE INVENTION

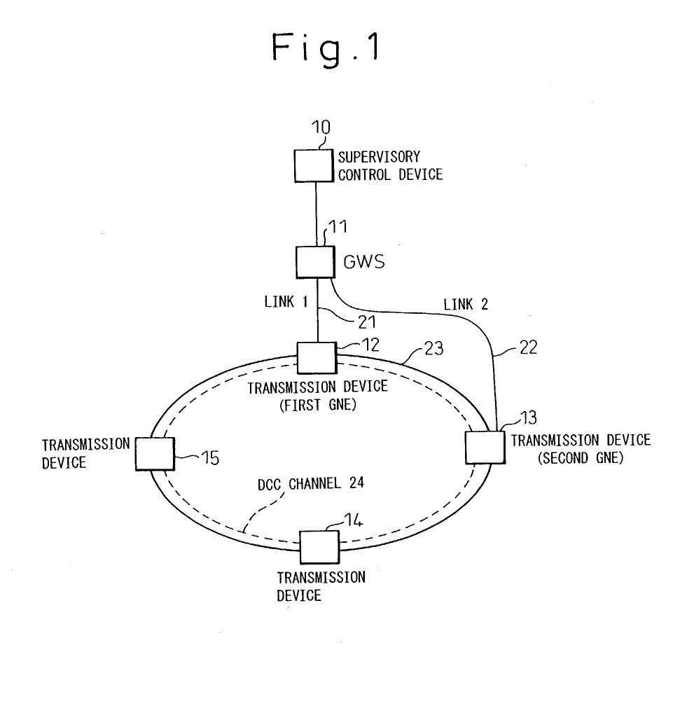

FIG. 1 shows the basic configuration of an example of a network supervisory control system according to the present invention.

In FIG. 1, transmission devices 12 to 15 connected in a ring by optical cables communicate supervisory control information with each other in the ring network. The supervisory control information is transmitted as SDH header information D1, D2, and D3 of SDH optical signals transmitted on the optical cables 23. The supervisory control information is transmitted on the supervisory control lines (DCC channels 24), between transmission devices, shown with a dotted line in FIG. 1. A supervisory control device 10 is physically connected with a particular transmission device (GNE) of the transmission devices 12 to 15 via a gateway server (GWS) 11 in order to perform the supervisory control of the ring network, and performs transmission of supervisory control information based on a predetermined communication protocol. In this example, physical links 21 and 22 each using different cables are provided between the gateway server 11 and a plurality of GNEs (two GNEs 12 and 13 in this example).

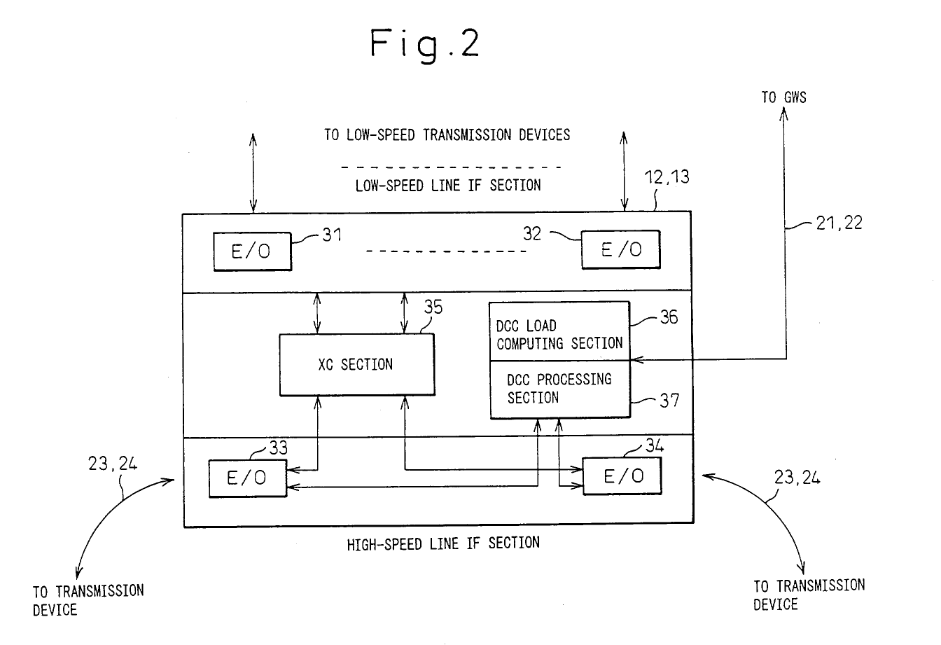

FIG. 2 shows the configuration of an example of a GNE according to the present invention. Each of the transmission devices 12 to 15 comprise a high-speed line interface (IF) section having SDH high-speed optical signal interfaces 33 and 34 for connection with other transmission devices in a ring, a low-speed line interface (IF) section having electrical signal interfaces 31 and 32 for low-speed SDH optical signals, digital lines, LANS, etc., to connect with equipment such as exchangers, routers, or low-speed transmission devices constituting networks at a lower level of this transmission device, and a transmission control section having a cross connecting (XC) section 35 for performing cross connection processing between the high-speed IF section and the low-speed IF section, a DCC processing section 37 for performing supervisory control of DCC signals, etc. The DCC processing section 37 performs an assembling/disassembling processing for SDH headers and transmits DCC information created by separating, processing, or inserting address information, health check information, or warning information, etc., between transmission devices.

In case of a GNE 12 or 13 according to the present invention, it further comprises external interfaces, for example, LAN interfaces such as 10Base-T or 100Base-T, and/or ISDN line interfaces, to connect with an external supervisory control device 10 and a gateway server according to the present invention. It further comprises a DCC load computing section 36 for performing various kinds of traffic-statistics processing for DCC traffic conditions of the DCC processing section 37 and executing DCC traffic check commands received from the gateway server 11 to send out the executing result to the supervisory control device 10 and/or the gateway server 11 through the external interfaces.

The gateway server 11 determines the traffic condition of the network based on a computing result notified autonomously from the DCC load computing section 36 of a transmission device which was set as a GNE (hereinafter called “first GNE”) by the initial setting, etc., or a computing result sent as a response to a command received from the gateway server 11. When the traffic is beyond a predetermined threshold, the gateway server 11 links up a new supervisory line between the gateway server 11 and a second GNE 13 which was reserved. Commands to be transmitted from the supervisory control device 10 to the transmission devices are divided and transmitted to the first and the second GNES 12 and 13, and thereby the load carried by only the first GNE 12 can be distributed to the first and second GNES, and load on the first GNE 12 can be reduced accordingly. Furthermore, DCC traffic information obtained by the second GNE 13 and DCC traffic information from other transmission devices received by the second GNE 13 are transmitted directly to the gateway server 11 from the second GNE 13, and thereby the congestion of a traffic can be distributed.

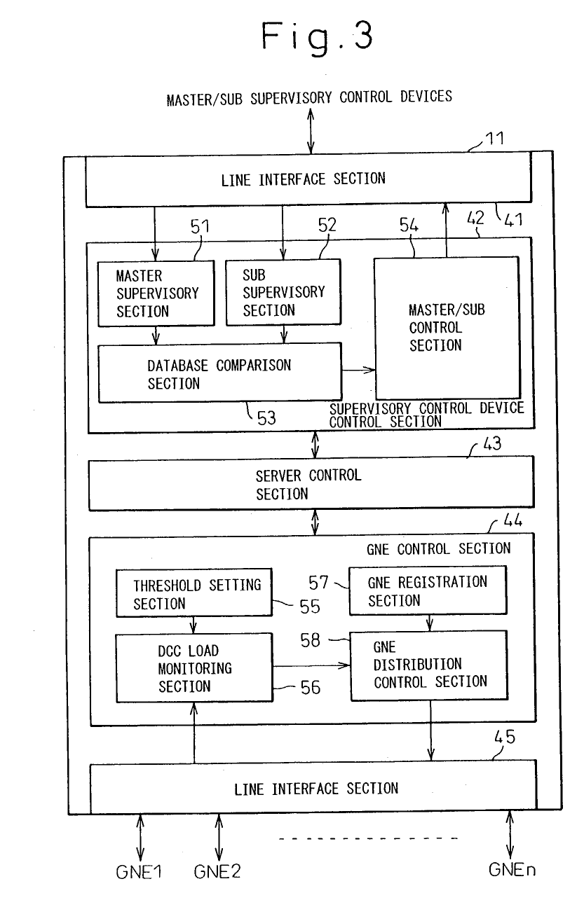

FIG. 3 shows the configuration of an example of a gateway server according to the present invention.

In FIG. 3, the line interface section 41 connected to the supervisory control device 10 utilizes LAN interfaces such as 10Base-T, 100Base-T, etc. On the other hand, the line interface section 45 connected to the GNES 12 and 13 utilizes, in addition to the LAN interfaces, ISDN interfaces to connect with transmission devices at remote locations. Below is described the GNE control section 44 of the gateway server 11 in connection with FIG. 1.

At first, the GNE distribution control section 58 sends a predetermined command through the line interface section 45 in order to check DC traffic conditions of the first GNE 12 under operation. For example, this command is for diagnosing message processing delay time, as explained in the following examples. The first GNE 12 receives said command and transmits the result of corresponding processing in the DCC load computing section 36 to the gateway server 11. The DCC load monitoring section 56 always monitors DCC traffic information received from the first GNE 12 through the line interface section 45, and compares the DCC traffic information with a predetermined threshold set in the threshold setting section 55 in advance. When the DCC traffic information is beyond the threshold, the DCC load monitoring section 56 sends this information together, with a GNE registration number, to the GNE distribution control section 58.

According to the information, the GNE distribution control section 58 notifies the transmission device 13 which has been uniquely assigned as a next GNE in the GNE registration section 57. The transmission device 13 assigned as a second GNE performs the same GNE processing as the first GNE 12. The aforementioned predetermined threshold may be fixed or dynamically varied. As an example of the latter case, a threshold for a traffic statistic information amount may be changed as appropriate according to the variation of a traffic depending on a time period of day, on a holiday, in the event of disaster, due to a special event, or depending on a season of year, or the like. Furthermore, it is also possible that a plurality of transmission devices 13 to 15 are registered in the GNE registration section 57 in advance, and the GNE distribution control section 58 performs, when assigning another GNE, the processing of establishing communication with the other transmission devices 13 to 15 which have been registered, and selects one of the transmission devices, with which communication can be established, as another GNE.

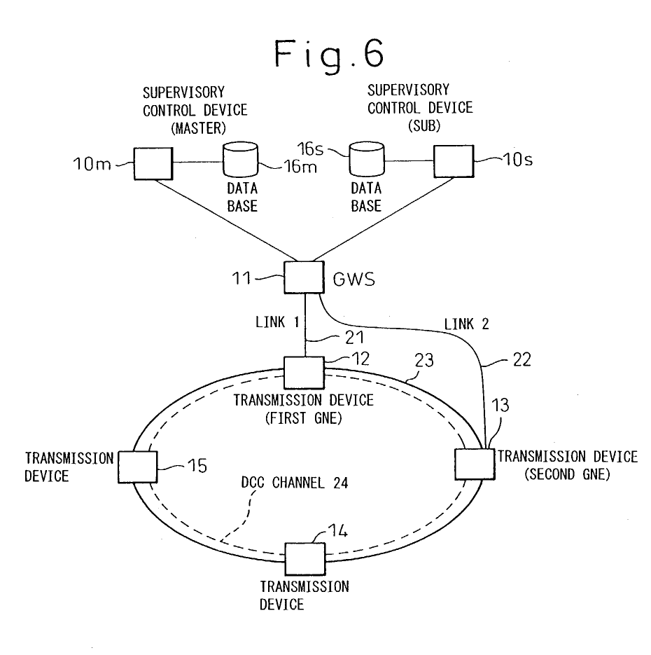

The server control section 43 controls the aforementioned processing of the GNE control section 44, etc., as a whole, based on the traffic information from the GNEs 12 and 13 which are clients, and notifies necessary information to the supervisory control device 10. On the other hand, according to commands from the supervisory control device 10 to which an operator provides instructions, the server control section 43 changes settings in the gateway server 11 and provides necessary information and/or indications such as a health check, to the GNEs 12 and 13 and the transmission devices 14 and 15 other than the GNEs under the control of the gateway server 11. Here, the supervisory control device control section 42 of the gateway server 11 is not explained, but will be explained in connection with an embodiment of the present invention shown in FIG. 6, described later.

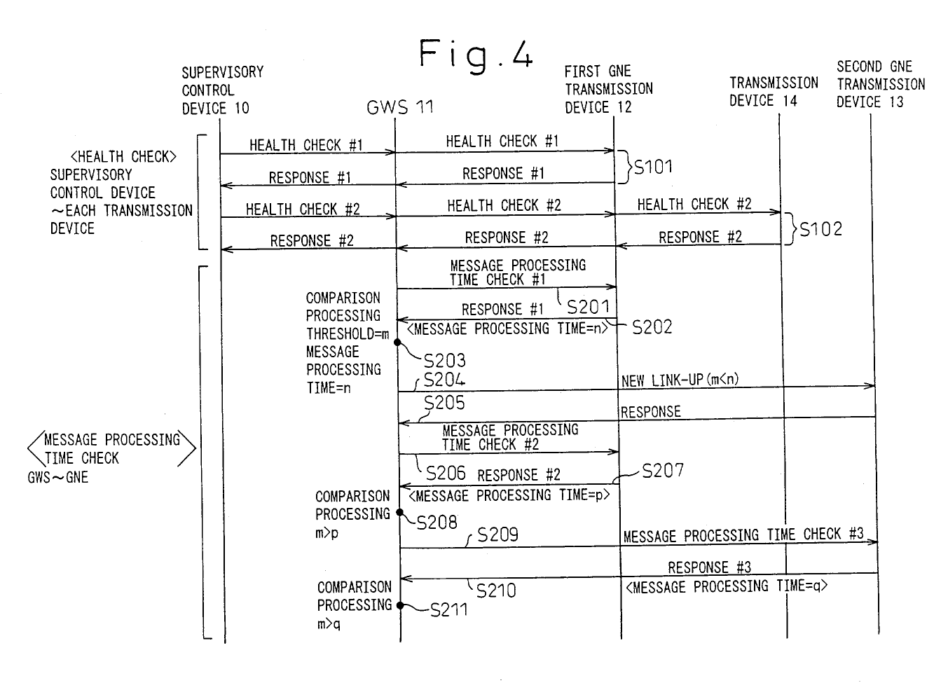

FIG. 4 shows an example of a link switching sequence of the system shown in FIG. 1.

As shown in FIG. 4, the supervisory control device 10 transmits health check commands to the transmission devices 12 and 14 when a health check program routine is started by the manual operation of an operator, or is periodically started, and then checks the normality of the transmission devices 12 and 14, and transmission cables between them, etc., by responses to the commands (Sl01 and S102). The supervisory control device 10 performs the monitoring based on the information notified autonomously by the transmission devices 12 and 14 or the results of health check commands issued to the transmission devices 12 and 14.

On the other hand, the distribution control section 58 of the gateway server 11 sends a diagnostic command for DCC traffic conditions to the first GNE 12 independent from the supervisory control device 10. In this example, a command for checking a message processing time of the GNE 12 is sent as an example of the diagnostic command, periodically (S201). The first GNE 12 transmits a corresponding result (message processing time=n) computed by the DCC load computing section 36 to the gateway server 11. The DCC load computing section 36 of the gateway server 11 compares the received computation result n with a predetermined threshold m set in the threshold setting section 55, and if m<n, it determines that the first GNE 12 is in a high traffic condition and notifies that to the GNE distribution control section 58 (S203). In this case, the GNE distribution control section 58 selects a second GNE 13 from the transmission devices registered in the GNE registration section 57, and then notifies a new link to the second GNE 13 (S204). In reply to this notification, the second GNE 13 transmits a response of accepting the notification to the gateway server 11 (S205).

After that, the distribution control section 58 of the gateway server 11 sends a message processing time check command to each of the first and second GNEs 12 and (S204 and S209). The GNEs 12 and 13 transmit a corresponding computation result (message processing time=p) and a corresponding computation result (message processing time=q) to the gateway server 11, respectively (S207 and S210). In this example, the computing results are m>p and m>q, which indicate that both the first and second GNEs 12 and 13 act normally within allowable DCC traffic. If either of the computation results p and q is beyond the threshold m a new GNE is added to distribute the congestion of a traffic on the corresponding GNE.

FIG. 4 shows processing if traffic has increased. In other cases, for example, if a GNE has gone down, a new supervisory line may be linked up between the gateway server 11 and another GNE in the same procedure by the operation of an operator or automatically, in order to continue the supervisory processing. Furthermore, the distribution control section 58 of the gateway server 11 may be configured so as to be able to indicate the stop and restart of GNE operation by supervisory processing. In this case, a load to be processed by the gateway server 11 itself, in a low load condition, can be reduced by reducing the number of GNEs to be monitored in accordance with DCC traffic conditions, and thereby the processing speed of the gateway server 11 can be increased and overprocessing in the gateway server can be prevented. Thus, the operation mode of the system can be maintained as appropriate in accordance with network conditions.

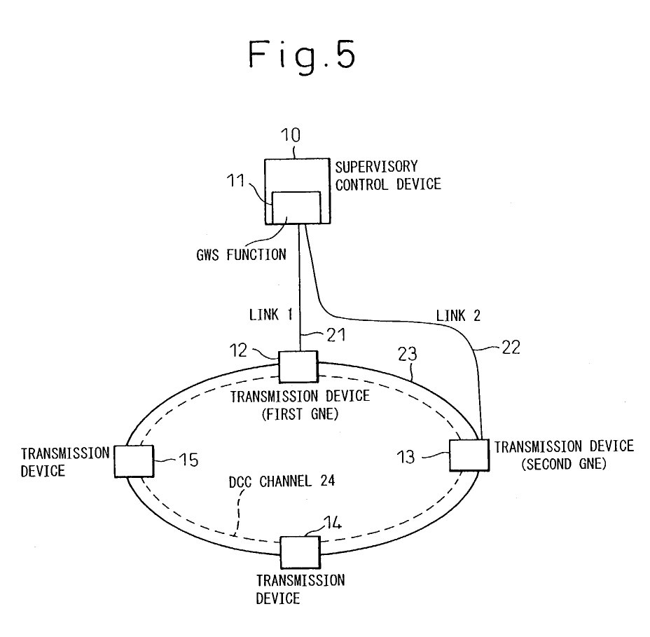

FIG. 5 shows a variation of the system shown in FIG. 1.

In the system shown in FIG. 5, a gateway server is not provided and the function of the gateway server 11 is incorporated into the supervisory control device 10. This system has an advantage that interfaces, cables, etc., between the supervisory control device 10 and the gateway server 11 shown in FIG. 1 are not required. However, this system requires that both of a supervisory control device function and a gateway server function should be performed at the same time in one supervisory control device, so that this system has lower throughput than the system configured as shown in FIG. 1, and is suitable for a small-scale network such as a corporate network in which priority is given to cost performance. The operation of this system is identical with that described above and is not described here.

FIG. 6 shows the configuration of another example of a network supervisory control system according to the present invention.

As can be understood from FIG. 6, configurations of the gateway server 11 and the transmission devices 12 to 15 are identical to the ones shown in FIG. 1 and the operations are also identical to the ones in FIG. 1. This system has features that two supervisory control devices, a master supervisory control device 10m and a sub-supervisory control device 10s, are provided and data bases 16m and 16s for storing network supervisory information are further provided to the supervisory control devices 10m and 10s respectively. The configuration of the gateway server 11 of this system will be described with reference to FIG. 3. The supervisory control device control section 42 includes a master supervisory section 51 and a sub-supervisory section 52 for performing state confirmation of the master and the sub-supervisory control devices respectively, a database comparison section 53 for comparing the data contents of the master database 16m and the data contents of the sub-databases 16s, and a master/sub control section 54 for performing control to match the data contents of the master database 16m with the data contents of the sub-databases 16s. When data is written into the respective databases, or at regular intervals, the data contents of the databases 16m and the data contents of the database 16s, respectively collected by the master and sub-supervisory control sections 51 and 52, are compared by the database comparison section 53. If a difference is detected, the master/sub control section 54 corrects the data contents of the sub-database 16s to match them to the data contents of the master database 16m. By this process, state inconsistency between a plurality of supervisory control devices can be prevented.

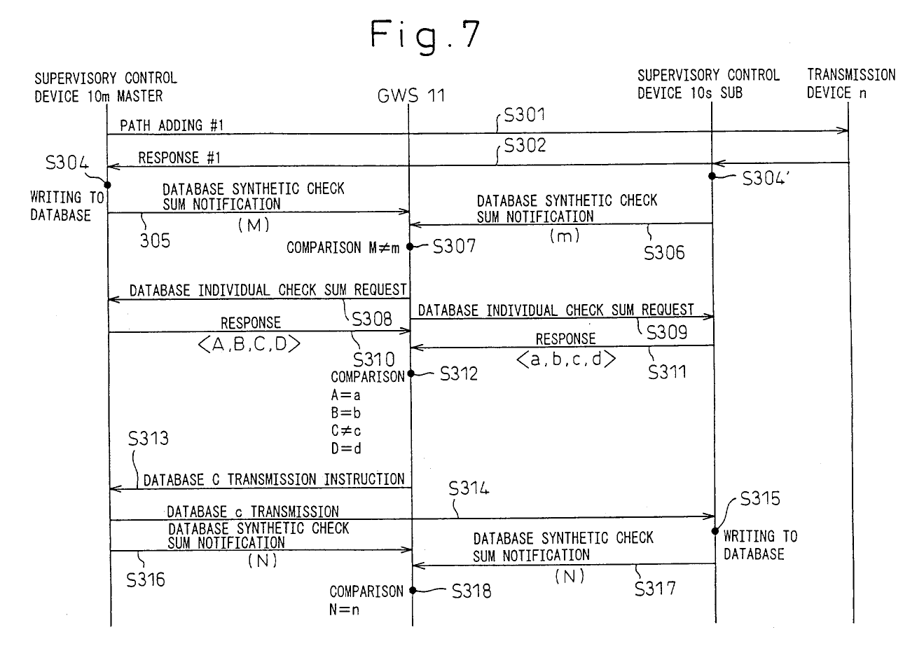

FIG. 7 shows an example of a database matching sequence of the system shown in FIG. 6. In this sequence, only the master supervisory control device 10m can send commands, and both of the master and sub-supervisory control devices 10m and 10s receive responses to the commands, and write the received responses into the databases 16m and 16s respectively.

FIG. 7 shows an example sequence if the master supervisory control device 10m transmits a path adding command to the transmission device n through the gateway server 11 (S301). The transmission device n sends a response to the path adding command (S302). This response is received by the master and sub-supervisory control devices 10m and 10s and is written into the databases 16m and 16s (S304 and S304′). By these operations, the master and sub-databases are usually consistent with each other in data contents. The master and sub-supervisory control devices then notify the respective database synthetic check sums (M, m), which are obtained as a result of writing the response into the respective database, to the gateway server 11 (S305 and S306).

The gateway server 11 receives the check sums through the master and sub-supervisory sections 51 and 52, and compares the check sums by the database comparison section 53. This example shows a case that the received database synthetic check sums have become inconsistent with each other from some reason (S307). In this case, the master/sub control section 54 sends a database individual check sum request relative to this writing to the master and sub-supervisory control devices 10m and 10s (S308 and S309). The master/sub control section 54 compares individual data (A and a, B and b, C and c, D and d) of the database individual check sum responces, and detects inconsistency between C and c in this example (S310 to S312).

As a result, the master/sub control section 54 instructs the master supervisory control device 10m to transmit data C, and the data C is transmitted to the sub-supervisory control device 10s in the form of data c (S313 and S314). At these steps, the gateway server 11 may relay data c to transmit it to the sub-supervisory control device 10s as above, or the master supervisory control device 10m may transmits data c directly to the sub-supervisory control device 10s. The sub-supervisory control device 10s writes the received data c into the database 16s, and then sends a database synthetic check sum notification to the gateway server 11 for confirmation (S315 and S317). The master supervisory control device 10m also sends a database synthetic check sum notification to the gateway server 11 for comparison, and, thereby, the gateway server 11 confirms that the master and sub-databases are consistent with each other (S316 and S318).

It is shown, in this example, that a response to a command sent from the master supervisory control device 10m is received by both of the master and sub-supervisory control devices 10m and 10s, although it is also possible that such a resonse is not received directly by the sub-supervisory control device 10s and all data may be written into the database 16s through the gateway server 11. In this case, the process at step S307 in FIG. 7 certainly result in an inconsistency, the subsequent steps are consequently performed, and then the master and sub databases become consistent with each other (S308 to S318).

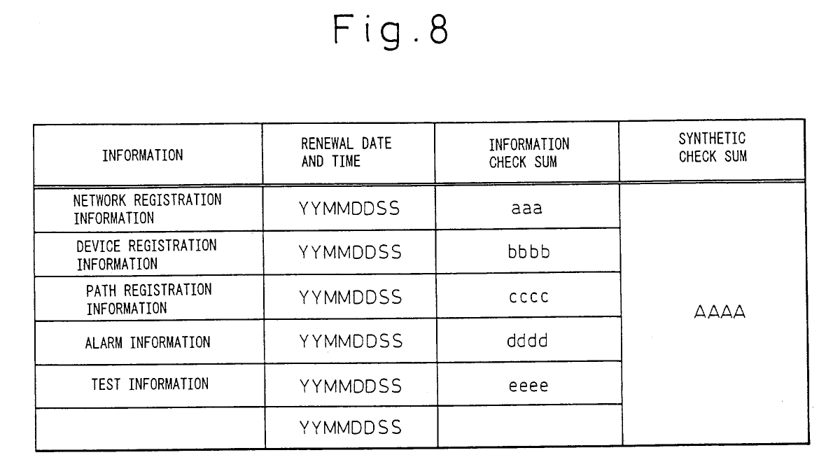

FIG. 8 shows an example of data contents of the database of a supervisory control device. Databases of the supervisory control devices of the system shown in FIG. 8 include, for example, network registration information, device registration information, path registration information, alarm information, test information, etc., each of which is furnished with renewal date and time and an information check sum. The databases further include a check sum of all databases in the supervisory control device. The most right column is a column for a database synthetic check sum (AAAA) and the next column on the left side of it is a column for database individual check sums. In accordance with the example shown in FIG. 7, at first, database synthetic check sums AAAA transmitted from the master and sub-supervisory control devices 10m and 10s are compared by the gateway server 11. If the both check sums are not consistent with each other, the gateway server 11 requests each of the supervisory control devices to send database individual check sums to it. In response to the request, the supervisory control devices 10m and 10s transmit the respective database individual check sums (aaa, bbbb, cccc, dddd, - - - ) to the gateway server 11. In this case, information check sums cccc of path registration information are inconsistent with each other. The gateway server 11 requests the master supervisory control device 10m to transmit the path registration information to the sub-supervisory control device 10s, and then the master supervisory control device 10m sends it to the sub-supervisory control device 10s. The sub-supervisory control device 10s updates the path registration information of the sub database 16s. Finally, the gateway server 11 compares database synthetic check sums transmitted again from the master and sub-supervisory control devices 10m and 10s, and confirms that the both check sums are consistent with each other.

In the example shown in FIGS. 7 and 8, database information is transmitted to the gateway server 11 when each of the supervisory control devices renews its database, although, regardless of that, it may be arranged that the master and sub-supervisory control devices 10m and 10s always transmit database information shown in FIG. 8 to the gateway server 11. Furthermore, it may be arranged that when the gateway server 11 compares database individual check sums and identifies the information difference therebetween, it refers the renewal dates and times (YYMMDDSS) of the information, and determines which database is the latest one so as to make the databases 16m and 16s consistent with the latest one, regardless of whether the latest one is the database 16m or 16s.

Furthermore, in the system shown in FIG. 6, which is handled by an operator, the following procedure may be applicable. The gateway server 11 transmits a signal representing that a difference has occurred between the databases of both of the supervisory control devices 10m and 10s, and warns an operator by causing a warning message to pop up on the screens of the supervisory control devices 10m and 10s and/or by generating a buzzer sound. The operator who has been given this warning performs the work to match the databases with each other. That is, the operator issues a command to match databases of the supervisory control devices with each other. As a result, the data contents of the database whose renewal date and time are the latest ones are transmitted the other database, thereby automatically matching the databases of the supervisory control devices with each other.

As described above, according to the present invention, a necessary response speed of the supervisory control device for various operations of transmission devices can be maintained in case of a surge of troubles on the transmission devices. Furthermore, also if a GNE has gone down due to trouble, etc., the operation of the supervisory control device can be secured and the effect on the operation of the network can be minimized. Furthermore, if the number of transmission devices in a ring network has increased or the number of ring networks has increased, a necessary response speed of the supervisory control device for various operations of transmission devices can be maintained and the effect on the network operation can be minimized.

1. A network supervisory control system comprising:
a supervisory control device for performing supervisory control of a network;
a plurality of transmission devices connected with each other to constitute said network;
at least one particular transmission device, of said plurality of transmission devices, having a gateway function for traffic information in said network; and
a gateway server disposed between said supervisory control device and said particular transmission device, through which said supervisory control device and said particular transmission device are connected,
wherein said gateway server monitors traffic conditions in said network given from said particular transmission device, and assigns a transmission device, other than said particular transmission device, to a new particular transmission device when predetermined traffic information is beyond a predetermined threshold, to link up a new supervisory line between said gateway server and said new particular transmission device.

2. The system of claim 1, wherein said particular transmission device includes a load computing section for performing computation to a command, which requests measurement of time for predetermined data processing, transmitted by said gateway server.

3. The system of claim 2, wherein said gateway server includes:
a threshold setting section for having said predetermined threshold;
a load supervisory section for monitoring said predetermined traffic information, comparing said predetermined traffic information with said predetermined threshold of, and notifying, when said predetermined traffic information beyonds said predetermined threshold, that to a particular transmission device distribution control section; and
said particular transmission device distribution control section for transmitting a command which requests measurement of time for predetermined data processing, assigning a transmission device other than said particular transmission device to a new particular transmission device to link up a new supervisory line between said gateway server and said new particular transmission device, and performing load distribution control for said particular transmission device by releasing the link under a predetermined condition.

4. The system of claim 3, wherein said predetermined threshold of said threshold setting section is a fixed value or a value dynamically varying according to predetermined conditions.

5. A network supervisory control system comprising:
a plurality of supervisory control devices for performing supervisory control of a network;
databases furnished to said plurality of supervisory control devices respectively;
a plurality of transmission devices connected with each other to constitute said network;
at least one particular transmission device, of said plurality of transmission devices, having a gateway function for traffic information in said network; and
a gateway server disposed between said plurality of supervisory control devices and said particular transmission device, through which said plurality of supervisory control devices and said particular transmission device are connected,
wherein said gateway server monitors matching states between said plurality of databases, and when detecting inconsistency of data contents between said plurality of databases, said gateway server matches data contents of databases other than a particular database with data contents of said particular database.

6. The system of claim 5, wherein
said plurality of supervisory control devices consist of a master supervisory control device and a sub-supervisory control device, and
said gateway server includes:
a master/sub-monitoring section for monitoring check sums on database contents from said master and sub-supervisory control devices;
a database comparison section for comparing said check sums and notifying, when said check sums are not consistent with each other, this to a master/sub control section; and
said master/sub control section for matching the contents of the database of said master supervisory control device with the contents of the database of said master supervisory control device.

7. The system of claim 5, wherein said gateway server monitors traffic conditions in said network transmitted from said particular transmission device, and assigns a transmission device other than said particular transmission device to a new particular transmission device, when predetermined traffic information is beyond a predetermined threshold, to link up a new supervisory line between said gateway server and said new particular transmission device.

8. The system of claim 1, wherein:
said network is a ring network, for transmitting SDH signals, constituted by said plurality of transmission devices connected in a ring;
said particular transmission device is a particular transmission device in said ring network; and
said traffic is DCC traffic in said ring network.
